(19) United States
(12) Patent Application Publication
(10) Pub. No.: US 2017/0349146 A1
(43) Pub. Date: Dec. 7, 2017

(54) KEYLESS VEHICLE SYSTEM THAT ENABLES SERVICING

(71) Applicant: Ford Global Technologies, LLC, Dearborn, MI (US)

(72) Inventor: Venkatesh Krishnan, Canton, MI (US)

(73) Assignee: Ford Global Technologies, LLC

(21) Appl. No.: 15/174,592

(22) Filed: Jun. 6, 2016

(51) Int. Cl. B60R 25/30; B60R 25/24

(52) U.S. Cl. CPC B60R 25/307; B60R 25/241; B60R 2325/205

(57) ABSTRACT

A method and system for servicing keyless vehicles is provided. The keyless vehicles include security systems that permit operation of the keyless vehicles if the security system receives a unique security signal from a smartphone. The method includes receiving a service request and unique first security data information from a customer concerning a location of a first keyless vehicle that requires service. An authorized person is transported to the first keyless vehicle in a second keyless vehicle. A customer's smartphone is provided with unique second security data whereby a customer can enter and operate the second keyless vehicle utilizing the customer's smartphone. The authorized person drives the first keyless vehicle to a service facility utilizing a second smartphone that is configured to generate a security signal to permit operation of the first keyless vehicle.

### CROSS-REFERENCE TO RELATED APPLICATION

The present application is related to U.S. patent application Ser. No. 15/174,206 filed on even date herewith, entitled “KEYLESS CAR SHARING MECHANISM USING SMARTPHONES AND INBUILT WIFI SYSTEMS FOR AUTHENTICATION”, the disclosure of which is hereby incorporated herein by reference in its entirety.

### FIELD OF THE INVENTION

The present invention generally relates to a keyless vehicle/servicing system, and in particular to a system/method that permits picking up and dropping off vehicles to be serviced and loaner vehicles without physically transferring a conventional key or keyfob for entry and operation of the vehicles.

### BACKGROUND OF THE INVENTION

Maintenance and servicing of motor vehicles is normally required. Typically, a customer drops off a vehicle at a vehicle servicing center, and arranges for transportation that can be used by the customer while the vehicle is being serviced. For example, the servicing center may provide the customer with a loaner vehicle that is driven by the customer while the customer's vehicle is being serviced.

However, scheduling service, and arranging for transportation can be problematic.

### SUMMARY OF THE INVENTION

One aspect of the present disclosure is a method of servicing keyless vehicles. Each keyless vehicle includes a security system including a wireless communication system that is capable of communicating with a remote wireless device such as a smartphone. The security system permits entry and operation of the keyless vehicle if the security system receives a unique (authorized) security signal or code from a smartphone. The security system of the keyless vehicles can be configured to require receipt of a security signal that is unique to a particular keyless vehicle. The method utilizes a security program for smartphones that permits smartphones to generate an authorized signal that is received by the security system of the keyless vehicles via the wireless communication system. A user utilizes a smart phone to unlock/unlatch and enter the vehicle and to operate the keyless vehicle. The smart phone may be provided with unique security data for one or more specific vehicles whereby the smart phone is able to generate a unique security signal (e.g. wireless) as required by the security systems of the specific keyless vehicles. The unique security data may comprise a numerical code or other suitable data. The security data provides a unique “key” that can be utilized to enter and/or operate a specific keyless vehicle. The method includes receiving a service request and unique first security data for a first keyless vehicle, from a customer. Information concerning a location of a first keyless vehicle requiring service is also received. A technician or other authorized person is transported to the first keyless vehicle in a second (loaner) keyless vehicle. A customer's smartphone that is equipped with the security program is provided with unique second security data concerning the second/loaner keyless vehicle whereby a customer can enter and operate the second/loaner keyless vehicle utilizing the customer's smartphone. The authorized person enters and operates the first keyless vehicle utilizing a second smartphone that is equipped with the security program and has access to the unique first security data. The authorized person drives the first keyless vehicle to a service facility where the car is serviced. After the vehicle has been serviced, an authorized person can drive the first keyless vehicle to a location selected by the customer utilizing a second smartphone, and the authorized person can then drive the second keyless vehicle back to the service facility.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a flow chart showing a first step of a process for providing vehicle service;

FIG. 1A is a schematic view of a system incorporating the steps of FIG. 1;

FIG. 2 is a flow chart showing a second step of a process for providing vehicle service;

FIG. 2B is a schematic view of a system incorporating the steps of FIG. 2;

FIG. 3 is a flow chart showing a third step of a process for providing vehicle service; and

FIG. 3C is a schematic view of a system incorporating the steps of FIG. 3.

### DETAILED DESCRIPTION OF THE PREFERRED EMBODIMENTS

For purposes of description herein, the terms “upper,” “lower,” “right,” “left,” “rear,” “front,” “vertical,” “horizontal,” and derivatives thereof shall relate to the invention as oriented in FIG. 4. However, it is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical charac-teristics relating to the embodiments disclosed herein are not to be considered as limiting, unless the claims expressly state otherwise.

The present application is related to U.S. patent application Ser. No. 14/718,448 filed on May 21, 2015 and entitled “ALTERNATE BACKUP ENTRY FOR VEHICLES,” U.S. patent application Ser. No. 14/880,377, filed on Oct. 12, 2015 and entitled “KEYLESS VEHICLE SYSTEM,” U.S. patent application Ser. No. 14/468,368, filed on Aug. 26, 2014 and entitled “ELECTRONIC VEHICLE SECURITY SYSTEM DEVOID OF LOCK CYLINDERS,” U.S. patent application Ser. No. 14/468,634, filed on Aug. 26, 2014 and entitled “KEYLESS VEHICLE DOOR LATCH SYSTEM WITH POWERED BACKUP UNLOCK” all of which are incorporated herein by reference in their entirety.

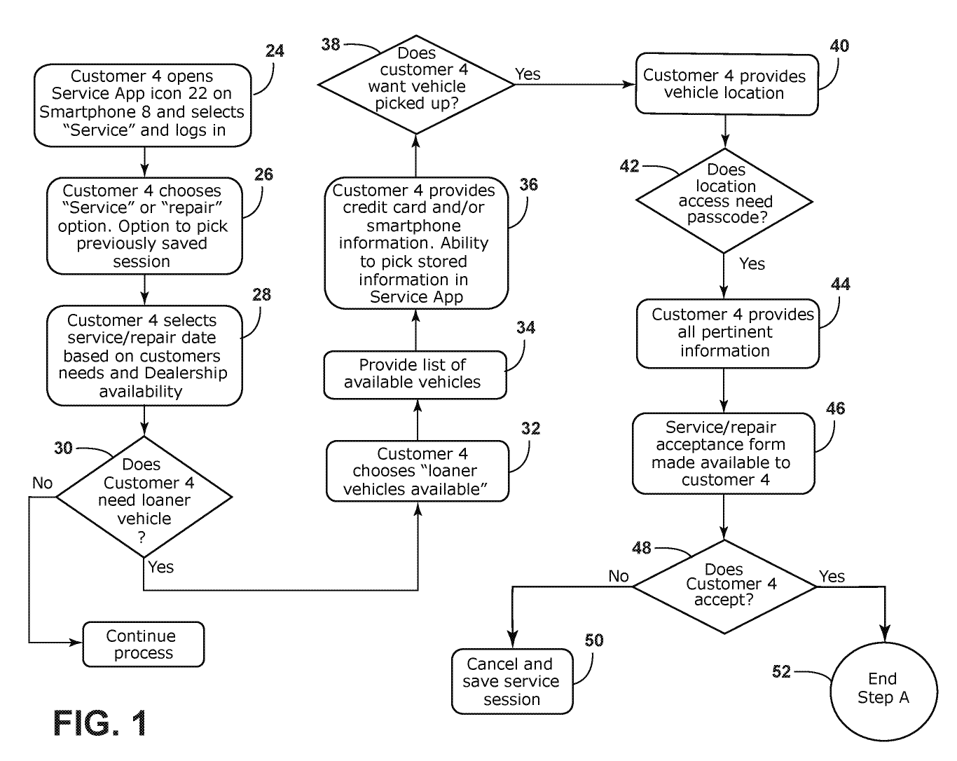

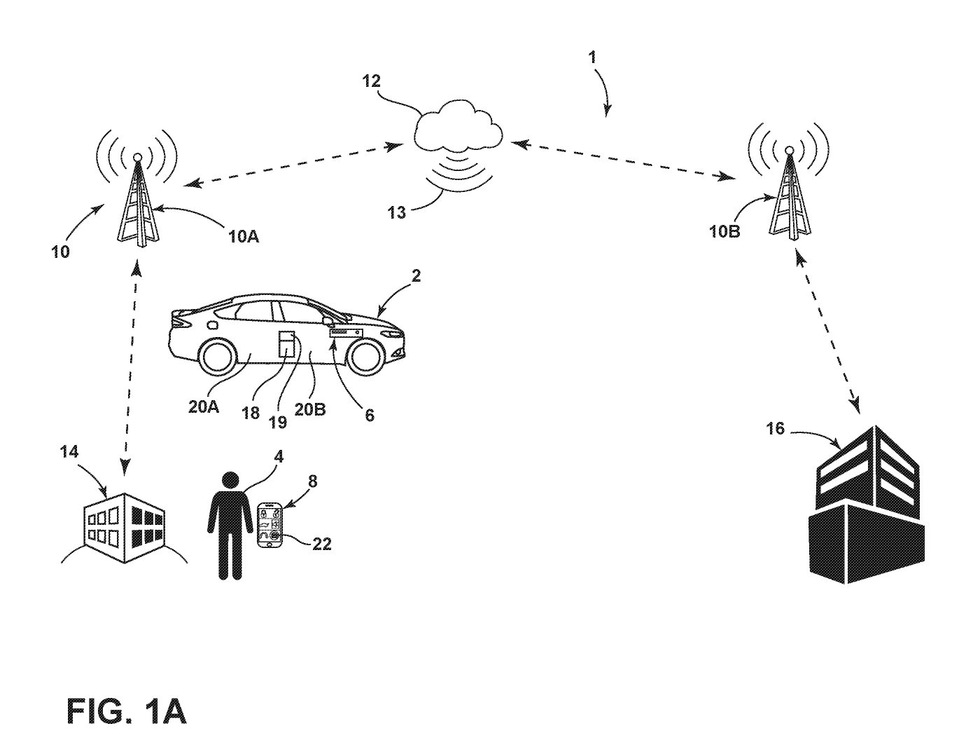

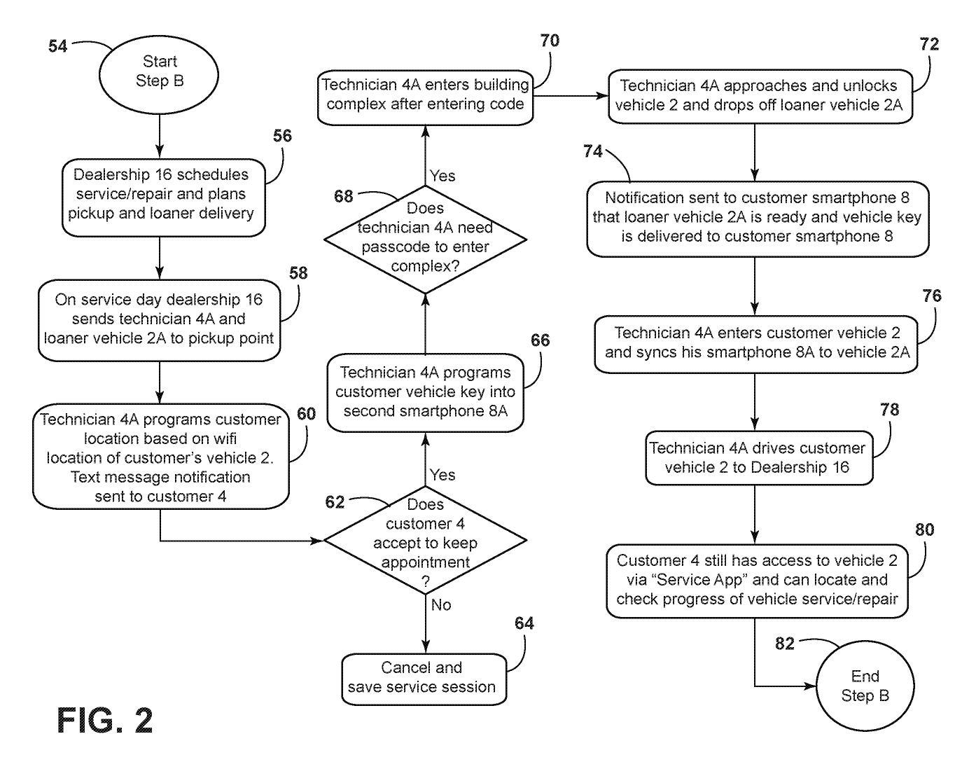

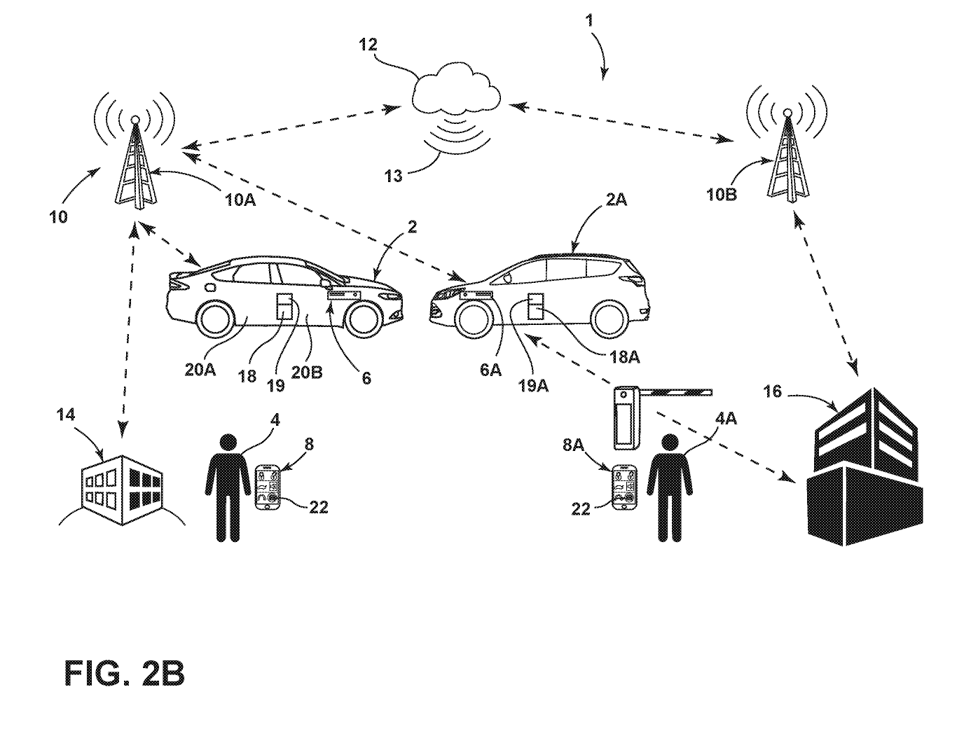

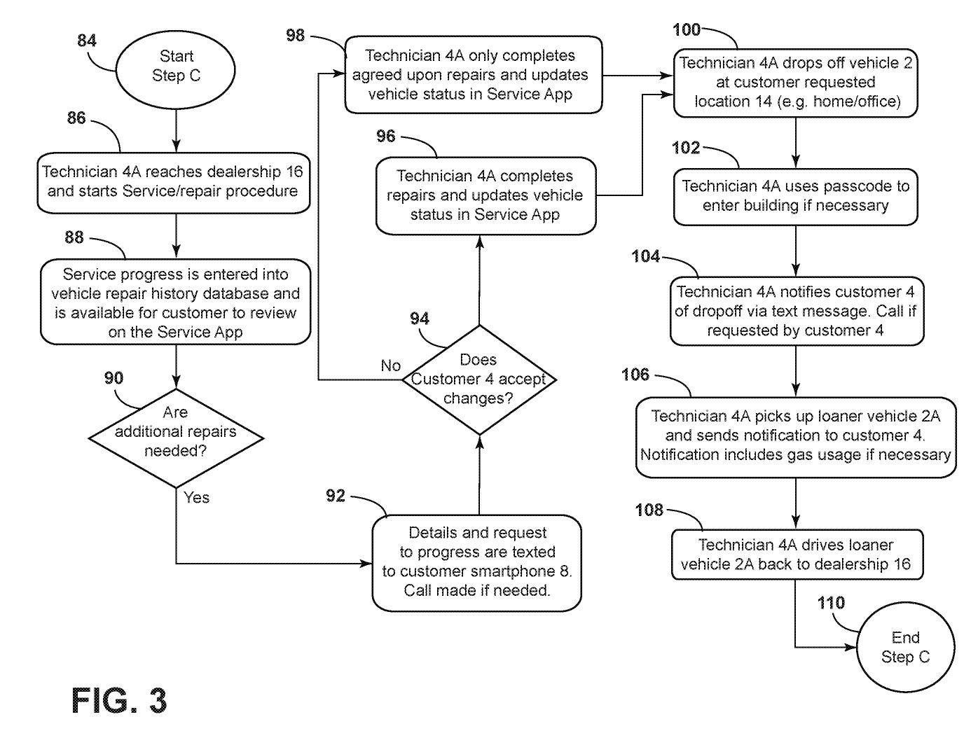

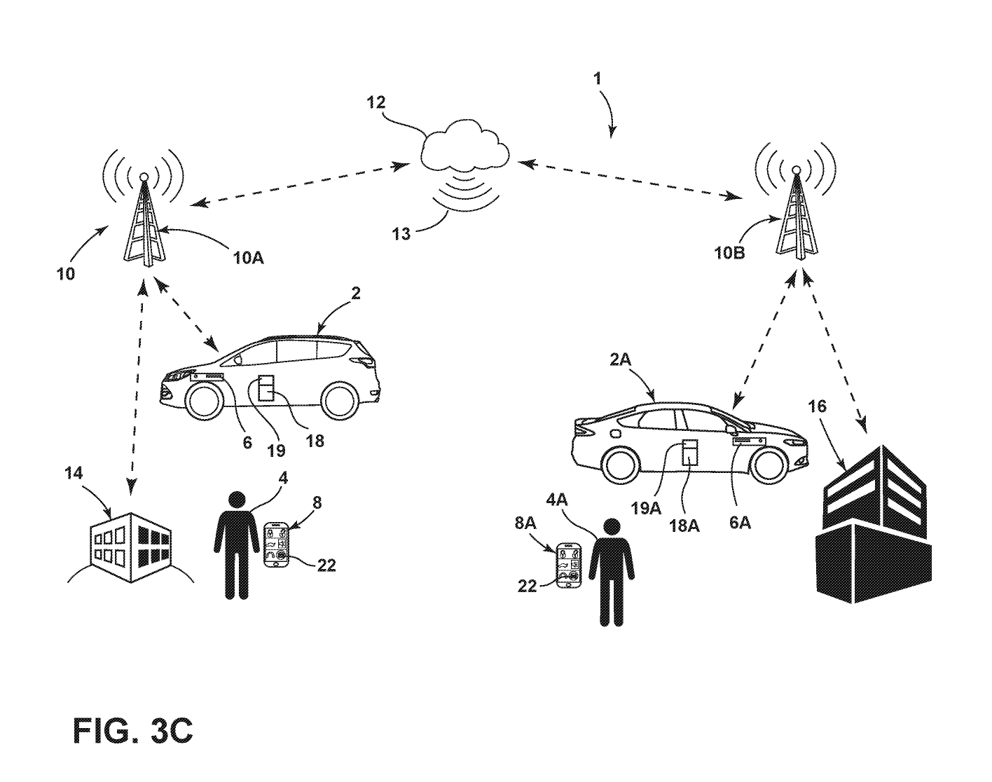

For purposes of description, a keyless vehicle servicing system/method is described herein as including Step A (FIGS. 1 and 1A), Step B (FIGS. 2 and 2B), and Step C (FIGS. 3 and 3C). FIGS. 1, 2, and 3 are flow charts showing Steps A, B, C, respectively, and FIGS. 1A, 2B, and 3C are schematic drawings showing steps A, B, and C, respectively. However, it will be understood that the present invention is not limited to any particular steps, combination of steps, or sequence of steps, and the arrangement of the system and method as described herein in connection with the Figures is not limiting with respect to the scope of the invention, unless the claims explicitly recite specific steps, sequences, and/or other limitations.

With reference to FIGS. 1 and 1A a system 1 includes a first keyless vehicle 2 that is owned, leased, or otherwise used by a customer 4. Keyless vehicle 2 includes a wireless communication and security system 6 that is configured to communicate wirelessly with a first wireless device 8 that is operated by customer 4. The wireless device 8 may comprise a mobile cell phone, smartphone, or the like that may be programmed with a security program. The smartphone 8 is configured to communicate wirelessly with security/wireless communication system 6 of keyless vehicle 2 utilizing a cellular data system 10 including cell towers 10A, 10B, etc. and other related components. The cellular system may provide access to a global communications network 12 (e.g. the internet) that connects and exchanges data 13 to computers and other devices. A user's home or office 14 may include one or more computers (not shown) and/or other devices that communicate with smartphone 8 and/or security/wireless communication system 6 and/or network 12. Similarly, a garage/vehicle service facility 16 (e.g. a car dealership having a repair facility) may also include one or more computers (not shown) and/or other devices that communicate via the cellular network 10 and/or the network 12.

As discussed in more detail in copending U.S. application Ser. No. 14/880,377 the security/wireless communication system 6 of keyless vehicle 2 is configured to communicate with smartphone 8. Smartphone 8 may be operably connected to system 6 of vehicle 2 directly by a line such as a USB cable, or it may communicate with system 6 directly or indirectly utilizing WiFi and/or cellular wireless signals. The smartphone 8 is configured to provide a unique security code (i.e. a digital “key”) that may be transmitted to the security/wireless communication system 6. Smartphone 8 can be configured to receive/acquire a digital key from a remote source to enable smartphone 8 to operate one or more keyless vehicles. If the security/wireless communication system 6 recognizes the digital “key,” the electronic latch system 18 of the keyless vehicle 2 can be unlocked by user/customer 4 to gain entry to the keyless vehicle 2. If the security key data is recognized by the security/wireless communication system 6, a user/customer 4 can then start and operate the keyless vehicle 2. Thus, the smartphone 8 operates as a wireless fob and provides Passive Entry/Passive Start (“PEPS”) capability/functionality that permits user entry and operation of keyless vehicle 2 without use of a conventional mechanical key. A plurality of keyless vehicles can be provided, and each keyless vehicle 2 can be configured to require receiving a unique digital key signal, whereby each keyless vehicle requires a different digital key for operation. A plurality of smartphones 8 having unique digital keys can be configured to operate a plurality of associated vehicles, whereby each smartphone 8 can operate an associated keyless vehicle. Optionally, a digital key for a specific keyless vehicle 2 may be acquired by more than one smartphone 8, whereby more than one smartphone 8 can operate a specific keyless vehicle 2. Also, a single smartphone 8 may optionally acquire more than one digital key, whereby a single smartphone 8 can be used to operate a plurality of keyless vehicles 2.

As discussed in more detail in U.S. application Ser. No. 14/880,377, keyless vehicle 2 may include a powered “E-latch” latch system 18 that utilizes electrically powered actuators to latch vehicle doors 20A, 20B, etc. without use of a mechanical key. The powered door latch system 18 is operably connected to the security/wireless communication system 6, and selectively locks/unlocks doors 20A, 20B etc., and also selectively unlatches/latches doors 20A, 20B, etc. according to predefined criteria. Because a conventional keyfob and/or a mechanical key is not required, the keyless vehicle 2 may be referred to herein as a keyless vehicle. However, it will be understood that a “keyless” keyless vehicle 2 may, optionally, include one or more conventional lock cylinders to provide emergency or backup vehicle access and/or operation in case the powered door latch system 18 is inoperable and/or to provide operation (e.g. ignition) of keyless vehicle 2 in the event the security/wireless communication system 6 is inoperable or disabled due to the loss of power, or the like. Thus, the term “keyless vehicle” as used herein generally refers to a vehicle that can be entered and/or operated without use of conventional mechanical keys.

The electronic latch system 18 may optionally include a user input device such as a touchpad 19. If a smartphone 8 is not available to transmit a wireless security signal to system 6/latch system 18 to actuate (unlock and/or unlatch) the vehicle door latches of electronic latch system 18, a user can input a vehicle access code using touchpad 19. If the access code entered using touchpad 19 is recognized by the security system 6, the latch system 18 unlocks and/or unlatches the vehicle door to permit a user to enter the interior of keyless vehicle 2. Vehicle 2 may include both a passive entry function provided by smartphone 8 and touchpad 19 for entry, or the vehicle 2 may include only passive entry, or only touchpad entry.

Referring to FIG. 1, the smartphone 8 may be configured/programmed utilizing a service app whereby the smartphone 8 displays an icon 22 (FIG. 1A). During a first step 24 of the process shown in FIG. 1, a customer opens a service app icon 22 on smartphone 8, and selects “service” and logs in. It will be understood that the smartphone 8 may include a touch screen, keys, audio recognition capabilities, and other user input features. Accordingly, it will be understood that the present invention is not limited to use of icons, touch screens, or other specific input features. Furthermore, it will be understood that the term “smartphone” as used herein generally refers to a mobile wireless communications device such as a cellular phone or the like that is capable of performing many of the functions of a computer and includes cellular and/or WiFi and/or Bluetooth wireless communication capability. However, the term “smartphone” as used herein is not limited to any specific device, but rather refers to virtually any mobile wireless device such as a cell phone, tablet, portable computer, or other wireless communication device.

After a user opens the service app at step 24, a user can then choose a “Service” or “Repair” option. The service app may be configured to provide an option to pick a previously saved session. At step 28, a user can select a service/repair date from a calendar, or by entering a date, based on the customer's needs and the dealership availability. The dealership (e.g. vehicle service facility/dealership 16, FIG. 1A) may have a computer system and/or smartphones that are configured to communicate with the smartphone 8 to provide data utilizing the service app concerning dates and/or times that are available for servicing a vehicle. Additional facilities 16 (e.g. dealerships or “garages”) may be connected to a central website that is operated by a central authority that coordinates and interconnects with individual websites for individual dealers.

At step 30, the customer may be prompted to indicate if a loaner vehicle is required. If a loaner vehicle is required, a prompt may appear on the cell phone 8 asking the customer to select “loaner vehicles available” or otherwise indicate that a loaner vehicle is required. At step 34, the service app provides a list of available vehicles that is displayed on the smartphone 8.

At step 36, the customer can provide credit card and smartphone information. The service app (program) on smartphone 8 may be configured to enable a user to select previously stored credit card and/or smartphone information. As discussed in more detail below, the smartphone information may include unique security data (a “key”) that can be used by authorized personnel from the vehicle service facility/dealership 16 to enter and operate the customer's keyless vehicle 2.

At step 38, a customer may be prompted to decide if the keyless vehicle 2 requiring services should be picked up at a location that is remote from the vehicle service facility/dealership 16. Step 38 may involve a prompt or other input feature provided by the service app on smartphone 8. If the customer's keyless vehicle 2 is to be picked up, the customer provides vehicle location information utilizing smartphone 8 at step 40. The smartphone 8 may be configured to require a passcode to provide location access as shown at step 42. At step 44, the customer provides all pertinent information. The pertinent information may include the location of keyless vehicle 2, pick up times, or other notes or information concerning the vehicle, pick up location, etc. If vehicle 2 includes a touchpad 19, the customer may provide the security code for touchpad 19.

At step 46, a service/repair acceptance form is made available to the customer. The service/acceptance form may comprise a digital file that is provided to the smartphone 8 of customer 4 by a vehicle service facility/dealership 16 utilizing the cellular network and/or network 12 (FIG. 1A). The smartphone 8 may be configured to provide an acceptance input that can be accepted or refused by a customer as shown at step 48. If the customer does not accept the form, the process is cancelled, and the service session (e.g. data entered by a user) is saved as shown at step 50. If the customer accepts the form at step 48, the process continues as shown by the circle 52.

The steps shown in FIG. 1 may be accomplished via a service App installed on smartphone 8, and/or via a computer or other suitable device having access to network 12.

The next part of the process “Step B” continues at start 54 as shown in FIG. 2. FIG. 2B is a schematic view showing the system 1 during step B shown in FIG. 2. As shown in FIG. 2B, the vehicle service facility/dealership 16 may utilize a second keyless vehicle 2A that includes a powered door latch system 18A and a security/wireless communication system 6A that correspond to the latch system 18 and security/wireless communication system 6, respectively of keyless vehicle 2. As discussed in more detail below, the second keyless vehicle 2A may comprise a loaner vehicle having a security/wireless communication system 6A that is configured to require a second unique security code or key to permit actuation of second keyless vehicle 2A. Keyless vehicle 2A may optionally include a touchpad 19A that provides for user input of a security code. Thus, keyless vehicles 2 and 2A may have substantially identical security/wireless communication systems 6, but the security/wireless communication systems 6 and 6A may be configured to require different security data/codes/keys to obtain entry and to operate the vehicles 2 and 2A.

Referring again to FIG. 2, step 54 is initiated if customer 4 requests that the customer's keyless vehicle 2 be picked up at a location that is remote from vehicle service facility/dealership 16, and if the customer 4 indicates that a second or loaner keyless vehicle 2A is required. At step 56, the dealership/service facility 16 schedules the service/repair, and plans for pickup of the customer's keyless vehicle 2, and also plans for delivery of a second or loaner keyless vehicle 2A to the location of the customer 4.

At the scheduled time/day, the facility/dealership 16 sends a technician or other authorized personnel 4A and loaner keyless vehicle 2A to the pickup point. The pickup point generally corresponds to the location information entered by the customer 4 as discussed above in connection with FIG. 1, and may comprise the customer's home or office 14. The technician 4A may utilize a smartphone 8A that has been programmed to include a service app that is substantially identical to the service app utilized by the customer's smartphone 8. The smartphone 8A may include second unique security data that is identified by the security/wireless communication system 6A of second keyless vehicle 2A to thereby enable technician 4A to enter and operate second keyless vehicle 2A.

As shown at step 60 (FIG. 2), the technician 4A may enter the pickup location specified by the customer into smartphone 8A. Alternatively, the keyless vehicles 2 and 2A may be configured to send GPS location information utilizing the cellular system 10 and/or network 12. Thus, if a customer 4 transmits a pass code for the location information of the keyless vehicle 2 to the facility/dealership 16, technician 4A can enter the pass code into second smartphone 8A such that the technician 4A can load location information concerning keyless vehicle 2 into smartphone 8A and/or security/wireless communication system 6A. As shown at step 60, the technician 4A may send a text message notification to the customer's smartphone 8 utilizing the smartphone 8A. For example, a text message indicating that the technician 4A is going to a specified location at a specified time to pick up the customer's keyless vehicle 2 may be sent.

As shown at step 62 (FIG. 2), the customer's smartphone 8 may provide a prompt, and customer 4 can accept or cancel the appointment. If the appointment is cancelled, the service session may be saved as shown at step 64. If the customer accepts the appointment, the technician 4A programs the customer vehicle security code/key into second smartphone 8A. Alternatively, the security code/key may be transmitted directly from first smartphone 8 to second smartphone 8A.

As shown at step 68, if technician 4A needs a pass code to enter a customer's home or office 14, the technician enters the building after entering the code as shown at step 70.

At step 72, technician 4A approaches and unlocks keyless vehicle 2, and drops off loaner keyless vehicle 2A. Because the smartphone 8A has been programmed to include the unique security data (i.e. the keys) for both wireless/keyless vehicles 2 and 2A, the technician 4A can enter and operate both wireless vehicles 2 and 2A utilizing smartphone 8A.

Alternatively, keyless vehicle 2 may be configured to require that the technician 4A to enter a security code using touchpad 19 to enter keyless vehicle 2. If keyless vehicle 2 is configured in this way, the technician 4A must “sync” smartphone 8A with system 6 prior to operating keyless vehicle 2. During the synching process, smartphone 8A communicates a security signal to vehicle system 6 wirelessly or via a USB cable or the like, and system 6 only completes the handshake and authorizes operation of keyless vehicle 2 if: 1) the correct security code is entered via touchpad 19, and 2) a smartphone 8A providing a recognized/authorized security signal is detected in the keyless vehicle 2. Thus, after technician 4A enters keyless vehicle 2, the vehicle 2 does not start unless the vehicle 2 recognizes smartphone 8A and the home office (dealership OEM) recognizes that the individual (smartphone number) is authorized to synch/handshake with keyless vehicle 2.

At step 74, notification is sent to the customer's smartphone 8 that the loaner keyless vehicle 2A is ready. The vehicle security data or key for the second keyless vehicle 2A is delivered to the customer's smartphone 8. The vehicle security data/key for the second keyless vehicle 2A may be transmitted wirelessly directly from second smartphone 8A to smartphone 8. If keyless vehicle 2A includes a touchpad 19A, the security code for touchpad 19A may be supplied to the customer 4 via smartphone 8 or other device.

The technician 4A then drives the customer's keyless vehicle 2 to the facility/dealership 16 as shown at step 78. As shown at step 80 the customer 4 still has access to keyless vehicle 2 via the service app, and can locate the keyless vehicle 2 and/or check the progress of the vehicle service/repair for the keyless vehicle 2 utilizing the smartphone 8. Step 82 corresponds to the end of Step B shown in FIG. 2.

With further reference to FIGS. 3 and 3C, step C begins at the oval designated 84. At step 86, technician 4A reaches the dealership (driving the customer's keyless vehicle 2), and starts the service/repair procedure. At step 88, the service progress is entered into the vehicle repair history utilizing second smartphone 8A and/or a computer or other suitable device (not shown) at the vehicle service facility/dealership 16. At step 90 if additional repairs are needed, details and a request to progress are texted or otherwise communicated to the customer's smartphone 8 as shown at step 92. The information may be transmitted from second smartphone 8A and/or other suitable devices (not shown) at dealership 16. A phone call may be made if needed.

If the customer does not accept changes as shown at step 94, the technician 4A only completes the previously agreed upon repairs as shown at step 98. The technician 4A also updates the status of the keyless vehicle 2 using the service app. If the customer does accept the changes at step 94, the technician 4A completes the repairs and updates the status of keyless vehicle 2 in the service app.

As shown at step 100, the technician 4A then drives the customer's keyless vehicle 2 to a drop off location (e.g. home/office 14) requested by a customer. As discussed above, technician 4A can utilize smartphone 8A to enter and operate the customer's keyless vehicle 2.

As shown at steps 102 and 104, the technician 4A uses a pass code supplied by the customer 4 to enter the building if necessary, and the technician 4A may notify the customer 4 that the keyless vehicle 2 has been dropped off utilizing a text message sent from smartphone 8A to smartphone 8 or by other suitable communication. Technician 4A may call customer 4 utilizing smartphone 8A if required/requested by a customer 4.

As shown at step 106, the technician 4A then picks up loaner keyless vehicle 2A and sends a notification to customer 4 (i.e. smartphone 8) utilizing smartphone 8A. The notification may include gas usage if necessary. The technician 4A can enter and operate loaner keyless vehicle 2A utilizing smartphone 8A as discussed above. As shown at step 108, the technician 4A then drives the second loaner keyless vehicle 2A back to the dealership 16, thus ending the processes shown at 110.

After the customer repossesses the keyless vehicle 2, the second smartphone 8A is reconfigured or reset to erase the digital key for the customer's keyless vehicle 2, such that smartphone 8A can no longer be used to operate keyless vehicle 2.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A method of transporting and servicing keyless vehicles, the method comprising:
providing a plurality of keyless vehicles, each keyless vehicle having a security system that is operably connected to a wireless communication system capable of communicating with a remote smartphone, wherein the security system is configured to permit entry and operation of the keyless vehicle upon receiving a security signal from a smartphone that is unique to each keyless vehicle;
providing a security program for smartphones that permits smartphones to be configured to receive unique security data for one or more specific keyless vehicles, and generate unique security signals that are received by the keyless vehicles, whereby a smartphone can be used to enter and operate specific keyless vehicles if the smartphone has acquired unique security data for the specific keyless vehicle;
receiving a service request for a first keyless vehicle that is associated with a first smartphone that is configured to generate a first security signal for entry and operation of the first keyless vehicle;
receiving unique first security data for the first keyless vehicle;
receiving information concerning a pick up location for the first keyless vehicle;
transporting an authorized person to the pick up location for the first keyless vehicle in a second keyless vehicle;
providing the first smartphone with unique second security data concerning the second keyless vehicle whereby the first smartphone is capable of generating a unique second security signal whereby the first smartphone can be utilized to enter and operate the second keyless vehicle;
wherein the authorized person enters and operates the first keyless vehicle utilizing a second smartphone that is configured to utilize the unique first security data to generate a unique first security signal.

2. The method of claim 1, wherein:
the authorized person drives the first keyless vehicle to a vehicle servicing facility.

3. The method of claim 2, wherein:
the authorized person wirelessly transmits the unique second security data to the first smartphone from the second smartphone.

4. The method of claim 3, wherein:
the unique second security data is transmitted to the first smartphone after the authorized person reaches the location of the first vehicle.

5. The method of claim 4, wherein:
the first smartphone is utilized to transmit at least one of the service request and the unique first security data.

6. The method of claim 4, including:
transporting the first keyless vehicle to a customer-specified location after the vehicle has been serviced utilizing a smartphone that is configured to generate a first security signal utilizing the unique first security data;
transporting the second keyless vehicle to the servicing facility utilizing a smartphone that is configured to generate a second security signal utilizing the unique second security data.

7. The method of claim 1, wherein:
the unique first security data is transmitted to a computer system at a vehicle servicing facility from a computer or a smartphone.

8. The method of claim 7, wherein:
the unique second security data is transmitted to the first smartphone from a computer system at a vehicle servicing facility.

9. The method of claim 1, wherein:
the first keyless vehicle includes at least one mechanical key cylinder that is configured to receive a key to permit entry into the vehicle and/or operation of the vehicle if the security system of the first keyless vehicle is disabled.

10. A method of transporting and servicing keyless vehicles that are configured to communicate with wireless communication devices that permit operation of the keyless vehicles without mechanical keys, the method comprising:
receiving a service request for a first keyless vehicle that is associated with a first wireless communication device, wherein the first wireless communication device is configured to generate a first security signal for operation of the first keyless vehicle utilizing unique first security data;
receiving unique first security data for the first keyless vehicle;
receiving information concerning a pick up location for the first keyless vehicle;
transporting an authorized person to the pick up location for the first keyless vehicle in a second keyless vehicle;
providing the first wireless communication device with unique second security data concerning the second keyless vehicle whereby the first wireless communication device is capable of generating a unique second security signal whereby the first wireless communication device can be utilized to operate the second keyless vehicle;
wherein the authorized person operates the first keyless vehicle utilizing a second wireless communication device that is configured to utilize the unique first security data to generate a unique first security signal.

11. The method of claim 10, wherein:
the first keyless vehicle includes a user input device that can be used to enter a security code that permits entry into the vehicle; and including:
providing the authorized person with an access code, wherein the authorized person enters the access code utilizing the user input device to thereby gain access to the vehicle interior.

12. The method of claim 11, wherein:
the user input device comprises a touchpad.

13. The method of claim 10, wherein:
the authorized person drives the first keyless vehicle to a vehicle servicing facility.

14. The method of claim 13, wherein:
the authorized person wirelessly transmits the unique second security data to the first smartphone from the second smartphone.

15. A method of servicing keyless vehicles that can be operated upon receiving unique wireless security codes, comprising:
receiving a first security code and location of a customer's remote vehicle;
using a smartphone to generate a wireless second security code to drive a second vehicle to the customer's vehicle, and to generate a wireless first security code and drive the customer's vehicle to a garage;
transmitting a second security code to a customer's smartphone.

16. The method of claim 15, wherein:
the customer's vehicle includes a touchpad;
entering a security code using the touchpad;
causing a door of the vehicle to unlock and/or unlatch if an authorized security code is entered using the touchpad.

17. The method of claim 15, wherein:
the customer's vehicle is configured to unlock and/or unlatch one or more vehicle doors if the vehicle receives a wireless security signal.

18. The method of claim 15, wherein:
a customer provides the first security code and vehicle location to a garage using the customer's smartphone.

19. The method of claim 15, including:
driving the customer's vehicle from the garage to a drop off location using a smartphone that is configured to generate a wireless first security code; and
driving the second vehicle from the drop off location to the garage using a smartphone that is configured to generate a wireless second security code.
